(19) United States
(12) Patent Application Publication
(10) Pub. No.: US 2004/0169476 A1
(43) Pub. Date: Sep. 2, 2004

(54) Mercury short arched lamp with a cathode containing lanthanum oxide

(76) Inventors: Dietmar Ehrlichmann, Berlin (DE); Lars Menzel, Berlin (DE)

Correspondence Address: OSRAM SYLVANIA INC, 100 ENDICOTT STREET, DANVERS, MA, 01923, US

(21) Appl. No.: 10/480,278

(22) PCT Filed: Mar. 5, 2003
(86) PCT No.: PCT/DE03/00709

(30) Foreign Application Priority Data
Mar. 5, 2002 (DE) 102 09 424.1

(51) Int. Cl. H01J 61/20; H01J 61/06

(52) U.S. Cl. 313/630; 313/639; 313/640; 313/637; 313/633

(57) ABSTRACT

The invention relates to a mercury short-arched-high pressure discharge lamp (1) which operates with direct-current, comprising a discharge vessel (2) having two necks (4) arranged in a diametrical manner opposite each other, wherein an anode (26) and a cathode (7), made respectively from tungsten, are melted in a gas-tight manner and said vessel is filled with mercury and at least one inert gas. According to the invention, the material of the cathode tip (11) contains, in addition to the tungsten, lanthanum oxide La₂O₃ and the mercury content of the filling in the discharging vessel volume is at least 1 mg/cm³ and at the most 6 mg/cm³.

### TECHNICAL FIELD

The invention relates to a short-arc mercury high-pressure discharge lamp for DC operation, comprising a discharge vessel having two necks fitted diametrically opposite each other, into which an anode and a cathode, each made from tungsten, are fused in a gastight manner, and which contains a filling of mercury and at least one noble gas. Lamps of this type are used in particular for microlithography in the semiconductor industry for exposing wafers.

### PRIOR ART

The short-arc mercury high-pressure discharge lamps used for the exposure process must supply a high light intensity in the ultraviolet wavelength range—to some extent restricted to a few nanometers wavelength—the generation of light being limited to a small spatial region.

The requirement derived from this for a high luminous intensity can be achieved by a DC gas discharge with short electrode spacing. In the process, a plasma is produced with high light emission in front of the cathode. As a result of the intensive electrical coupling of energy into the plasma, electrode temperatures are produced which, in particular in the case of the cathode, lead to damage to the material.

Cathodes of this type have therefore previously preferably contained a doping of thorium oxide ThO₂ which, during the lamp operation, is reduced to thorium Th, strikes the cathode surface in this metallic form and there leads to a reduction in the work function of the cathode.

Associated with the reduction in the work function is a reduction in the operating temperature of the cathode, which leads to a longer lifetime of the cathode since, at lowered temperatures, less cathode material evaporates.

The previously preferred use of ThO₂ as dopant is based on the fact that the evaporation of the dopant is relatively low and therefore leads to few disruptive deposits in the lamp bulb (blackening, coatings). The advantageous suitability of ThO₂ correlates with a high melting point of the oxide (3323 K) and of the metal (2028 K).

However, electrode burn-back cannot be avoided even in the case of thoriated cathodes, so that, in the case of the present DC discharge lamp, limits are placed on the lifetime as a result of the burning back of the cathode. This is a disadvantage in particular in the case of lamps with short electrode spacings, such as those here, since here slight burn-back of the electrode already leads to severe changes in the optical properties of the lamp. A further reduction in the burn-back therefore remains desirable.

However, the decisive disadvantage of the use of ThO₂ is its radioactivity, which makes safety precautions when dealing with the preparatory material and lamp production necessary. Depending on the activity of the product, regulations also have to be complied with in the storage, operation and disposal of the lamps.

The solution of the environmental problem is particularly pressing in the case of lamps with high operating currents of more than 20 A, as used in microlithography, since these lamps have a particularly high activity because of the electrode size.

Numerous thorium substitutes have therefore been investigated. Examples of these will be found in “Metallurgical Transactions A, vol. 21A, December 1990, pp 3221-3236. The commercial use of replacement substances in the case of lamps for microlithography has previously not been successful, since all replacement substances led to pronounced bulb coatings as a result of their easier evaporability as compared with ThO₂.

In microlithography, the productivity of exposers depends critically on the amount of light which the lamp provides. Bulb coatings or electrode burn-back reduce the available useful light and lead to a loss of productivity of the very expensive systems because of increasing exposure times.

### SUMMARY OF THE INVENTION

It is an object of the present invention to provide a short-arc mercury high-pressure discharge lamp according to the preamble of claim 1 which manages without radioactive dopants in the electrode material, ensures low electrode burn-back, is not inferior to the achieved prior art in relation to the electrode burn-back and, if possible, further reduces the formation of coatings in the lamp bulb over the lamp lifetime.

In the case of a short-arc mercury high-pressure discharge lamp, this object is achieved by the features of the preamble of claim 1 in that at least the material of the cathode head additionally contains lanthanum oxide La₂O₃ and the mercury content of the lamp filling is at most 6 mg/cm³. In this case, the mercury content should be at least 1 mg/cm³, since the plasma characteristics of pure noble gas lamps differ considerably from mercury arc lamps. In the absence of relatively easily ionizable mercury, a noble gas arc burns in a substantially more concentrated manner.

Investigations on different dopants had led to the result that La₂O₃ can exhibit very favorable results with regard to coating formation and electrode burn-back. The burn-back is even lower than in the case of thoriated materials. This is an advantage which becomes particularly effective in the case of short electrode spacings (<6 mm) and would make a certain excess of coating formation even tolerable. The doping of the head or of the entire cathode comprising shank and head should in this case lie between 1.0 and 3.5% by weight of the cathode material, better between 1.5 and 3.0% by weight of the cathode material.

The cathode operating temperature substantially determines the evaporation rate of the emitter. The Richardson-Dushman formula

I=AT²exp(−e^{φ}/kT),

where I is the current density in A/m², A the constant 1.2×10⁶ in A/m²K², k the Boltzmann constant, T the temperature in K and φ the work function in eV, produces a relationship between lamp current, electron exit surface and electrode temperature. At a given lamp current, the electrode temperature is not unambiguously determined, however. The size of the arc attachment area remains open and influences the cathode temperature.

Investigations have shown that the arc attachment area and therefore the electrode temperature are influenced by the type of filling gas, the filling gas pressure and the mercury concentration.

An influence of electrode diameter, the tip angle and electrode tip diameter is admittedly in principle also present, but the influence of these parameters when using La₂O₃ as an additive to the tungsten of the cathode material is of subordinate importance since, in addition to the current, it is primarily the lamp plasma characteristics which determine the shape of the arc attachment. For the plasma characteristics, however, type of filling gas, filling gas pressure and mercury concentration are important.

Trials have shown that, in particular high mercury concentrations in short-arc mercury high-pressure discharge lamps according to the invention effect particularly severe heating of the cathode tips. For example, with 4.5 mg/cm³ Hg, the electrode temperature is 2200° C., while with 40 mg/cm³ with the same current, 2600° C. is measured.

The emitter evaporation increases with the mercury concentration in such a situation. The investigations showed that, when La₂O₃ was used as an additive to the tungsten of the cathode material, similarly low evaporation rates could be achieved as when ThO₂ was used, provided the amount of mercury does not exceed 6 mg/cm³ as a filling in the discharge vessel.

By means of the addition of further oxides or carbides, attempts have been made to achieve further improvements. Here, it has been shown that, by means of the addition of ZrO₂ and/or HfO₂ in small quantities, a further improvement in the characteristics with regard to the emitter evaporation can be achieved. However, in this case the quantity of ZrO₂ and/or HfO₂ should not exceed 1.0% by weight in the case of ZrO₂ and 1.5% by weight in the case of HfO₂ in the cathode material, since the beneficial influence on the luminous flux is always associated with increased burn-back of the cathode.

A similar influence to that of the mercury content is had by the filling gas pressure in the lamp. With increasing filling gas pressure, the arc attachment point on the cathode is constricted and leads to an increased cathode tip temperature. Here, trials have shown that, when xenon Xe is used as filling gas, a cold filling pressure from 3 bar or 16.3 mg/cm³ Xe already leads to a noticeable emitter evaporation in the lamp type according to the invention.

The variation in the xenon filling pressure shows a considerable influence on the luminous flux. After 1500 h, in a short-arc mercury high-pressure discharge lamp according to the invention with a cathode material doped with 2% by weight of La₂O₃ in the cathode head and a mercury content of the filling of 4.5 mg/cm³, the following luminous flux values resulted as a function of the Xe filling gas pressure:

| Xe filling pressure | Luminous flux |
|---|---|
| 500 mbar | 81% |
| 800 mbar | 88% |
| 1500 mbar | 82% |
| 3000 mbar | 76% |
| 5000 mbar | 53% |

The results described initially permit the supposition that the lowest possible filling of mercury and filling gas are desirable. However, further investigations showed that, at very low operating pressures, the above-described relationship between filling pressure and emitter evaporation no longer applies. Instead, a converse relationship appears: the evaporation of the emitter increases again as the gas filling pressure falls.

This phenomenon may be explained by the noble gas pressure in the lamp opposing the evaporating particles as a diffusion barrier. The denser a gas, the more intensely it inhibits the emitter evaporation processes.

A minimum cold filling pressure of 500 mbar or 2.7 mg/cm³ is therefore necessary when xenon is used, in order to avoid excessive emitter evaporation.

The density range 2.7 mg/cm³=15.2 mg/cm³ (500 mbar-2800 mbar for Xe) supplies the most beneficial results and corresponds to a pressure range of 786-4425 mbar in the case of Kr and, respectively, 1648-9276 mbar in the case of Ar.

The preferred density range for the gas pressure on the basis of the investigations therefore lies between 2.7 and 15.2 mg/cm³ and neither an excessively low opposing pressure nor an excessively high electrode temperature leads to excessive emitter evaporation.

As a result of specifying a density range, different pressure regions result, depending on the gas, which is used to cover the various filling gases or their mixtures in a simple way.

The advantage of the low burn-back of La₂O₃-doped cathodes becomes significant only in the case of short electrode spacings, as in the case of the lamps here. Therefore, the electrode spacings in the short-arc mercury high-pressure discharge lamps according to the invention are particularly advantageously less than or equal to 6 mm.

### BRIEF DESCRIPTION OF THE DRAWINGS

In the following text, the invention is to be explained in more detail using a number of exemplary embodiments. In the drawing:

FIG. 1 shows a short-arc mercury high-pressure discharge lamp according to the invention in section

FIG. 2 shows a detailed extract of the cathode

### PREFERRED EMBODIMENT OF THE INVENTION

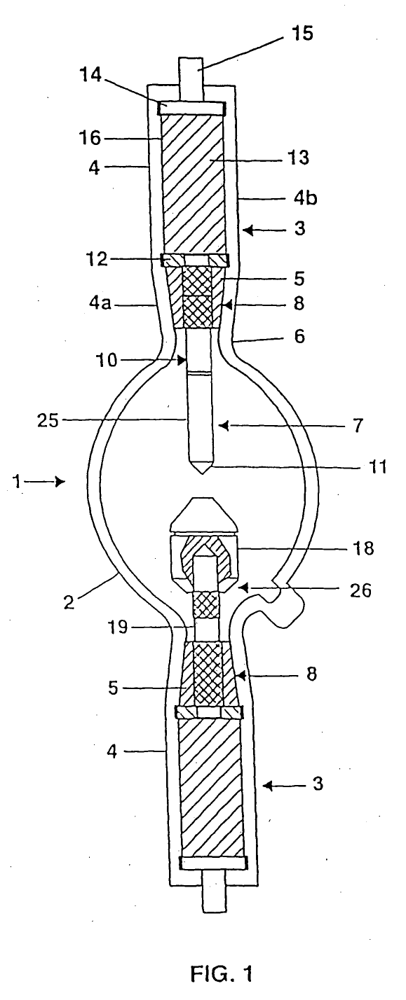

FIG. 1 shows, in section, a short-arc mercury high-pressure discharge lamp 1 according to the invention with an output of 1.75 kW. It has a bulb 2 of quartz glass, which is shaped elliptically. This is adjoined on two opposite sides by two ends 3, which are designed as bulb necks 4 and which each contain holding parts 8. The necks have a front conical part 4a, which contains a small supporting roll 5 of quartz glass as a substantial component of the holding part, and a rear cylindrical part 4b, which forms the seal. The front part 4a has a pulled-in section 6 of 5 mm length. This is in each case adjoined by a small supporting roll 5 with a central hole, which is shaped conically. Its internal diameter is 7 mm, its external diameter at the front end is 11 mm, the external diameter at the rear end is 15 mm. The wall thickness of the bulb 2 is approximately 4 mm in this region. The axial length of the small supporting roll is 17 mm.

Guided axially in the hole in the first small supporting roll is a shank 10 of a cathode 7 with an external diameter of 6 mm, which reaches as far as the discharge volume and there bears an integral head part 25. The shank 10 is lengthened toward the rear beyond the small supporting roll 5 and ends at a disk 12, which is adjoined by the seal in the form of a cylindrical quartz block 13. Behind this, there follows a second disk 14 which, at the center, holds an external current feed in the form of a molybdenum rod 15. On the outer surface of the quartz block 13, four molybdenum foils 16 are led along in a manner known per se and sealed to the wall of the bulb neck in a gastight manner.

In a similar way, the anode 26, comprising a separate head part 18 and shank 19, is held in the hole in the second small supporting roll 5.

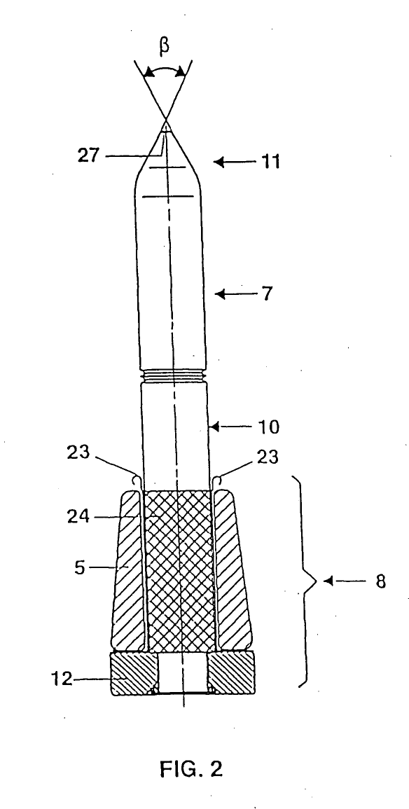

In FIG. 2, the cathode 7 and the holding part 8 are shown in detail. The cathode 7 is assembled from a circularly cylindrical shank 10 of 36 mm length and an integral head 25 of 20 mm length, the head 25 and the shank having an external diameter of 6 mm. The end of the head 25 which faces the anode is formed as a tip 11 with a tip angle β of 60° and has a plateau-shaped end 27 with a diameter of 0.5 mm. The holding part comprises small supporting rolls 5 and a plurality of foils in its hole.

For the purpose of mechanical isolation of small supporting rolls and shank, a foil 24 is wound repeatedly (two to four layers) around the shank. A pair of narrow foils 23, which are opposite each other on the wound foil 24, are used for fixing the small supporting roll. For this purpose, they project beyond the small supporting roll on the discharge side and are bent over outward. The material of the tip 11 of the cathode 7 has, in addition to tungsten, a doping of 2.0% by weight of La₂O₃.

The short-arc mercury high-pressure discharge lamp according to the invention has a discharge vessel with a volume of 134 cm³, which is filled with 603 mg of mercury and a noble gas mixture of xenon and argon in an amount of 720 mg.

The operating current of the lamp with an electrode spacing of 4.5 mm is around I=60 A. (The current density J in the cathode at a distance of 0.5 mm from the plateau tip is 66 A/mm² during operation of the lamp.)

1. A short-arc mercury high-pressure discharge lamp (1) for DC operation, comprising a discharge vessel (2) which has two necks (4) fitted diametrically opposite each other, into which an anode (26) and a cathode (7), each made of tungsten, are fused in a gas-tight manner and which contains a filling of mercury and at least one noble gas, characterized in that at least the material of the cathode tip (11) contains, in addition to tungsten, lanthanum oxide La₂O₃, and the mercury content of the filling in the discharge vessel is at least 1 mg/cm³ and at most 6 mg/cm³.

2. The short-arc mercury high-pressure discharge lamp as claimed in claim 1, characterized in that the cathode material of the entire cathode (7) additionally contains La₂O₃.

3. The short-arc mercury high-pressure discharge lamp as claimed in claim 1 or 2, characterized in that the La₂O₃ content of the cathode material is 1.0 to 3.5% by weight.

4. The short-arc mercury high-pressure discharge lamp as claimed in claim 1 or 2, characterized in that the La₂O₃ content of the cathode material is 1.5 to 3.0% by weight.

5. The short-arc mercury high-pressure discharge lamp as claimed in claim 1, characterized in that the filling gas or filling gas mixture has a density in the discharge vessel (2) of between 2.7 and 15.2 mg/cm³ of the discharge vessel volume.

6. The short-arc mercury high-pressure discharge lamp as claimed in claim 1, characterized in that the electrode spacing between anode (26) and cathode (7) in the discharge vessel (2) is less than or equal to 6 mm.

7. The short-arc mercury high-pressure discharge lamp as claimed in claim 1, characterized in that the lamp current during operation of the lamp (1) is greater than 20 A.
